(19) United States
(12) Patent Application Publication
(10) Pub. No.: US 2016/0080316 A1
(43) Pub. Date: Mar. 17, 2016

(54) Subscriber Identification and Provisioning in IP Translation Environments

(71) Applicant: NOKIA SOLUTIONS AND NETWORKS OY, Espoo (FI)

(72) Inventors: Enrique Javier GONZALEZ PIZARRO, Madrid (ES); Parag PADHYE, Munich (DE)

(21) Appl. No.: 14/784,608

(22) PCT Filed: Apr. 15, 2013
(86) PCT No.: PCT/EP2013/057829

§ 371 Date: Oct. 15, 2015

(51) Int. Cl. H04L 29/12

(52) U.S. Cl. CPC H04L 61/2503

(57) ABSTRACT

A method includes collecting interface information on a plurality of services. The services include core infrastructure and translation services. The method also includes correlating the interface information to provide subscriber and IP addressing information, and provisioning the subscriber and IP addressing information to different services based on a rule provisioning policy.

### TECHNICAL FIELD

This invention relates generally to the identification and provisioning of subscribers in a translation IP environment.

### BACKGROUND

This section is intended to provide a background or context to the invention disclosed below. The description herein may include concepts that could be pursued, but are not necessarily ones that have been previously conceived, implemented, or described. Therefore, unless otherwise explicitly indicated herein, what is described in this section is not prior art for the description in this application, and is not admitted to be prior art by inclusion in this section. Abbreviations that may be found in the specification and/or the drawing figures are defined below at the end of the “Detailed Description of the Drawings” section of the present specification.

Operators are continuously demanding new products and services to offer to their existing subscribers. In turn, new technologies and services are offering solutions based on a deep understanding of customer preferences and are providing effective customization of multi-tenant services.

When customers subscribe to an operator's services or products, they are given a unique identification (subscriber number/source IP address) to ensure that the services or products are available only to legitimate subscribers.

In the IP environment, the identification is carried out with the help of the subscriber number/source IP address. Up to the present time, IPv4 (IP version 4) has been the most commonly used IP protocol for the identification. For this purpose, operators use Authentication/Authorization/Accounting (AAA) services to identify subscribers and to assign IP addresses to them. This information is also provisioned to other services to activate services and networks policies based on a relation subscriber/Profile/IP address assigned attributes.

However, operators are now facing the challenge that the IP address range in IPv4 is becoming exhausted, and, as a consequence, they are seeking alternatives for creating more IP addresses. The alternatives are to move to IPv6 (IP version 6) and/or to deploy Network Address Translations (NAT) solutions.

Implementing NAT and IPv6 into operator's infrastructures introduces new challenges as the identity attribute “subscriber number/source IP address” is lost with the modification of IP address, either with tunnelization, which is the change from IPv4 to IPv6 or vice versa, or with the integration of network address translation that includes modification of source IP address with Network Address and Port Translator (NAPT).

This modification of the identity (subscriber number/source IP Address) has a great impact on the services that use these attributes to identify subscriber flow.

Hence, the key challenge which is addressed by the present invention is to accurately identify a subscriber's identity in the legacy and the next generation scenarios. This will also significantly aid the real-time and accurate provisioning of services for a subscriber.

The present invention provides a way in which this challenge might be met.

### SUMMARY

This section contains examples of possible implementations and is not meant to be limiting.

In an exemplary embodiment, a method includes collecting interface information on a plurality of services, said services including core infrastructure and translation services; correlating the interface information to provide subscriber and IP addressing information; and provisioning the subscriber and IP addressing information to different services based on a rule provisioning policy.

In another exemplary embodiment, an apparatus includes one or more processors; and one or more memories including computer program code. The one or more memories and the computer program code are configured, with the one or more processors, to cause the apparatus to perform: collecting interface information on a plurality of services, said services including core infrastructure and translation services; correlating the interface information to provide subscriber and IP addressing information; and provisioning the subscriber and IP addressing information to different services based on a rule provisioning policy.

In a further exemplary embodiment, an apparatus includes: means for collecting interface information on a plurality of services, said services including core infrastructure and translation services; means for correlating the interface information to provide subscriber and IP addressing information; and means for provisioning the subscriber and IP addressing information to different services based on a rule provisioning policy.

In an additional exemplary embodiment, a computer program product is disclosed including a non-transitory computer-readable storage medium bearing computer program code embodied therein for use with a computer, the computer program code comprising: code for collecting interface information on a plurality of services, said services including core infrastructure and translation services; code for correlating the interface information to provide subscriber and IP addressing information; and code for provisioning the subscriber and IP addressing information to different services based on a rule provisioning policy.

### BRIEF DESCRIPTION OF THE DRAWINGS

In the attached Drawing Figures:

FIG. 1 presents a simple communication service provider (CSP) architecture with an IP service translation based on NAT and IP tunneling;

FIG. 2 presents the simple CSP architecture as modified by the present invention;

FIG. 3 is a schematic representation of the internal modules used to implement the present invention;

FIG. 4 is a flowchart representing a detailed algorithm of the present core infrastructure correlation module; and

FIG. 5 is a flowchart representing a detailed algorithm of the present IP translation infrastructure correlation module.

### DETAILED DESCRIPTION OF THE DRAWINGS

AAA services are of tremendous importance for today's Internet because they provide the capacity to identify subscribers and use the identification to provide customizable services based thereon. AAA services have evolved to new identification frameworks and protocols to solve new challenges in the capacity of authentication, authorization and accountability for new services.

The most important identification in an operator's infrastructure is the relation between a subscriber and the IP address assigned to the subscriber to provide Internet connectivity, custom services and charging control.

With the necessity of addressing IPv4 exhaustion in the near future, different approaches to solve this problem have been proposed. Several of the approaches include IP tunnelization, which is the change from IPv4 to IPv6 or vice versa, and the implementation of Network Address Translations (NAT) solutions.

These solutions have a great impact on the capacity to identify subscriber IP flows. With the integration of these solutions, source IP addresses assigned to subscribers are modified with NAT, NAPT or tunnelization IP. In doing so, however, the relation between subscriber and IP address is lost. As a consequence, the ability to provide AAA and identity services is also lost.

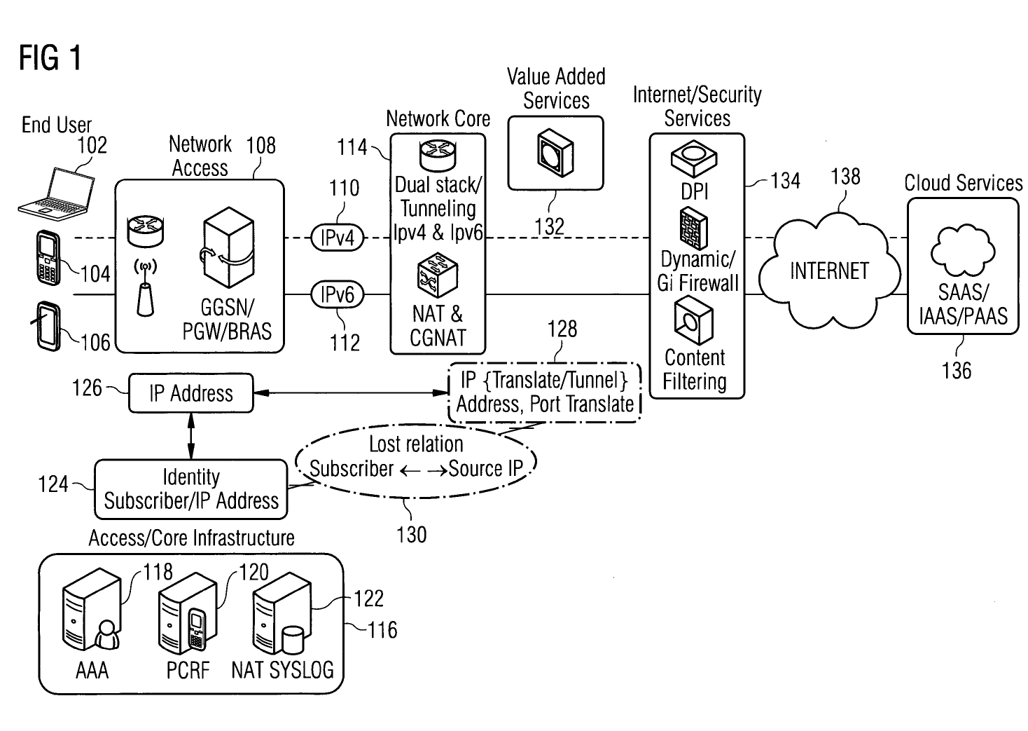

The problem is illustrated in FIG. 1, which shows a simple communication service provider (CSP) architecture with an IP service translation based on NAT and IP tunneling.

Referring now to FIG. 1, subscribers, or end users, are represented by devices commonly used to access on-line services: a laptop computer 102, a cell phone or user equipment (UE) 104, and a smart phone 106. Network access 108 is provided to each of these through a gateway GPRS support node (GGSN), a packet gateway (PGW), or a broadband remote access server (BRAS) using either IP version 4 (IPv4) 110 (dashed line in FIG. 1) or IP version 6 (IPv6) 112 (solid line in FIG. 1). In the network core 114, IPv4 addresses are translated into IPv6 addresses by tunneling, by network address translating (NAT), or by carrier grade network address translating (CGNAT), as illustrated below network core 114 in FIG. 1.

An unfortunate consequence of such translation is that the relationship between the subscriber and the IP address is lost when the IP address is translated. More specifically, the access/core infrastructure 116, which may include an AAA server 118, a PCRF server 120, or a NAT/NAPT SYS LOG server 122, identifies the subscriber by linking a subscriber number and an IP address (box 124), but when the IP address (box 126) is translated (box 128), the relationship between the subscriber and the IP address is lost (oval 130).

Subsequently, when the subscriber accesses value added services (box 132); internet/security services (box 134), such as deep packet inspection (DPI), dynamic GI firewall, and content filtering; and cloud services (box 136), such as software as a service (SAAS), infrastructure as a service (IAAS), and platform as a service (PAAS), through the Internet 138, it is difficult to provide flow identification based on the subscriber and his IP address.

In short, these scenarios, with AAA services and evolved IP topologies (NAT, IPv6) integrated into the operator topology, generate new problems for providing flow identification based on subscriber and IP address information.

The problems, if operators implement IPv6 or NAT solutions, are:
1. difficulty in providing IP flow identification per subscriber with a transparent method to the services implemented after network core with translate solutions (NAT, IPv6 tunneling);
2. not all network elements in an operator's infrastructure, for example, value-added service (VAS) servers, can support IPv6 and the tunneling protocol;
3. difficulty in providing subscriber/IP information to specific services that demand or support this transparent identification with AAA services or similar, after translate solutions implement source IP/Port modifications; and
4. issues with providing a mechanism for provisioning services by subscriber/IP address information in a transparent mode, because translate solutions (NAT, IPv6 tunneling) implement historical log infrastructures to storage IP/Port translation information that does not include AAA or provisioning IP services that provisioned this translation to other services.

Several approaches have been taken to partially manage this issue in these environments:
1. implementing an additional authentication mechanism to provide flow identification per subscriber, including a transparent mechanism based on subscriber identification deployment, such as, certificates, cookies, and the like;
2. implementing additional authentication mechanisms to provide flow identification per subscriber based on a non-transparent mechanism (login, captive portal); and
3. implementing an additional authentication mechanism based on evolved subscriber protocols, such as Extensible Authentication Protocol (EAP), Security Assertion Markup Language (SAML), and the like.

All of these ways require additional infrastructure, capital expenditure (CAPEX) and operational expenditure (OPEX), and the prerequisite that the subscribed services support this authentication, and are not a valid solution for services based on IP address identification.

In summary, these solutions are driven by service authentication and the capacity of the services to support these methods, and do not provide a generic or simple transparent authentication that can be demanded for simple services based on subscriber/IP identification, such as value-added services in the CSP networks or Cloud/Internet Services).

The present invention is primarily intended for service IP identification in any scenario, either IPv6 or a NAT environment. The present invention, on a high level, is an algorithm/module that implements and collects interfaces of different services that include core infrastructures and translation services; correlates this interface information in real time to provide centralized subscriber and IP addressing information; and provisions the subscriber and IP addressing information to different services based on a rule provisioning policy.

The proposed algorithm/module may be integrated into a specific service to provide this information, for example, a policy charging and rules function (PCRF), AAA infrastructure or NAT/IPv6 tunneling infrastructure, or may be deployed as a standalone module, where the operator does not have a PCRF, for example, supporting different connection interfaces.

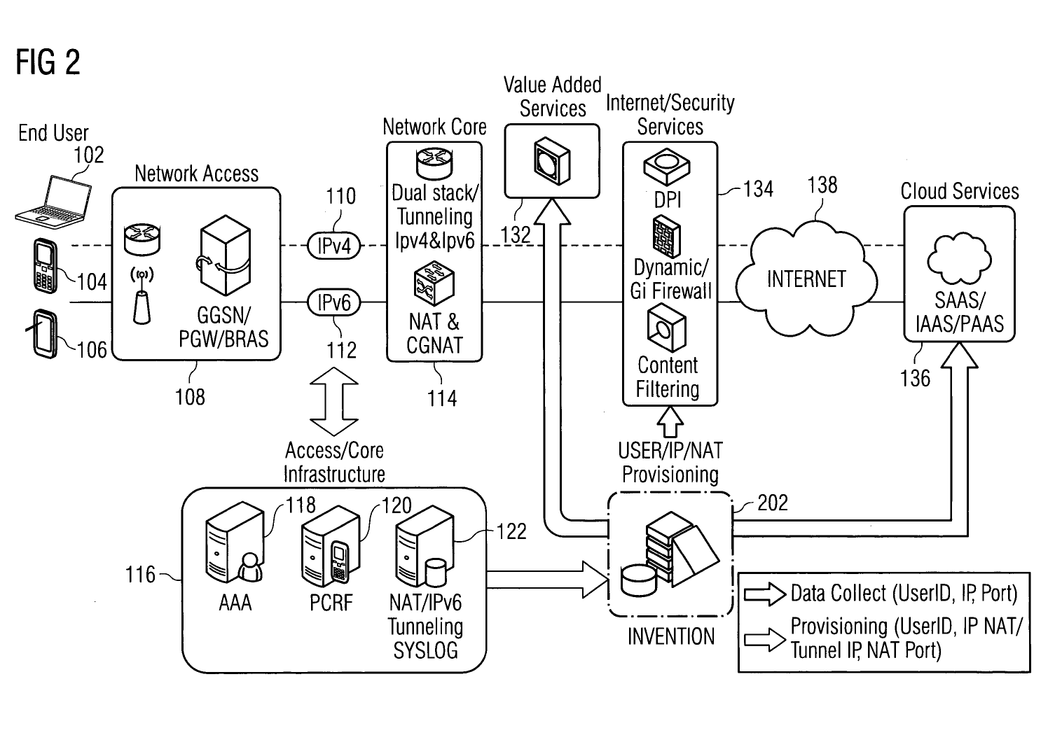

A sample integration proposal is provided in FIG. 2, which shows a simple CSP architecture, like that shown in FIG. 1, as modified in accordance with the present invention.

With reference now to FIG. 2, where elements appearing in FIG. 1 have been identified using the same drawing reference numbers, subscribers, or end users, are again represented by devices commonly used to access on-line services: a laptop computer 102, a cell phone or user equipment (UE) 104, and a smart phone 106. Network access 108 is provided to each of these through a gateway GPRS support node (GGSN), a packet gateway (PGW), or a broadband remote access server (BRAS) using either IP version 4 (IPv4) 110 (dashed line in FIG. 1) or IP version 6 (IPv6) 112 (solid line in FIG. 1). Bypassing the network core 114, the access/core infrastructure 116 collects the following information from the network:
a) subscriber/end user attribute identification (MSISDN, User name, . . . );
b) IP address assigned (IPv4 or IPv6);
c) Provisioning policy (default in case that isn't provisioned); and
d) Log information of NAT or IP tunnelization. This information includes NAT IP, NAT Port ranges, and tunneling IP. This can be a direct access to log repositories or capture traffic information inline.

The access/core infrastructure 116 then provides this information to the module 202 of the present invention. As a consequence, module 202 is able to maintain the relationship between the subscriber and the IP address. Subsequently, when the subscriber accesses value added services (box 132); internet/security services (box 134), such as deep packet inspection (DPI), dynamic GI firewall, and content filtering; and cloud services (box 136), such as software as a service (SAAS), infrastructure as a service (IAAS), and platform as a service (PAAS), through the Internet 138, flow identification based on the subscriber and his IP address is maintained.

Accordingly, key features of the present invention are, among other things:
1. It collects interfaces or capture traffic from AAA services and log IP translation services that provide subscriber, IP addressing and NAT Port ranges information, selecting only the information that is needed to provision other services (subscriber id, IP address, port ranges address);
2. It implements an internal repository to implement a subscriber/IP connection table to correlate and manage all information collected and to provide information needed for every service to be provisioned, and it provides a real time repository of subscribers/IP addressing information on the network;
3. It provides a rule mechanism to create the policy provisioning per service. This could be a policy management interface or an interface for requesting this information for an external service, such as PCRF;
4. It provides interfaces for provisioning external services and the capacity to evolve these interfaces to support future service requirements. (For instance, DIAMETER, SOAP, XML, RESTful web APIs). The module can implement Internet connectivity, for example, to cloud services that demand this information; and
5. It implements a fast repository, correlation algorithm and interfaces to minimize collect and provisioning delays that network could generate. This delay is minimized for the simplicity of the information to be provisioned.

As a result, subscriber and IP addressing information are provisioned in a controlled environment and provisioned to other services based on the operator and service requirements.

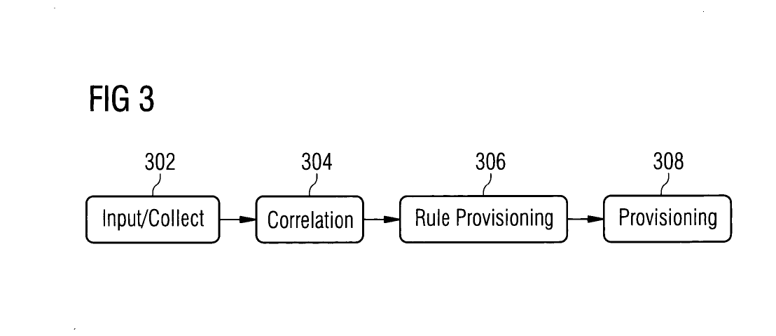

Accordingly, as illustrated schematically in FIG. 3, the present invention is a module that, among other things:
1. inputs and collects (box 302) interfaces of different services, that include AAA services, PCRF servers, NAT/IPv6 tunneling Log information;
2. correlates (box 304) the interface information in real time to provide a unique connection subscriber/IP table/Port ranges with the relation subscriber/IP address/Port ranges assigned;
3. implements a rule management to prepare and format this information based on the requirements of different services to be provisioned (box 306); and
4. provisions (box 308) this information (Subscriber/IP address) to the specific service with different interfaces supported (SOAP, XML, Diameter, etc.). Alternatively expressed, in box 302 (Input/Collect), subscriber and IP/Port information from different services, which include Core, translation and tunnel services with different standard interfaces/protocols, are collected. In box 304 (Correlation), subscriber/IP/Port information and management of session table per subscriber/IP, unique per subscriber, are correlated. In box 306 (Rule Provisioning), Policy/Rules for provisioned services, based on Subscriber/IP/Port information, are provisioned. Finally, in box 308 (Provisioning), Subscriber/IP/Port information to other services are provisioned based on provisioning rules.

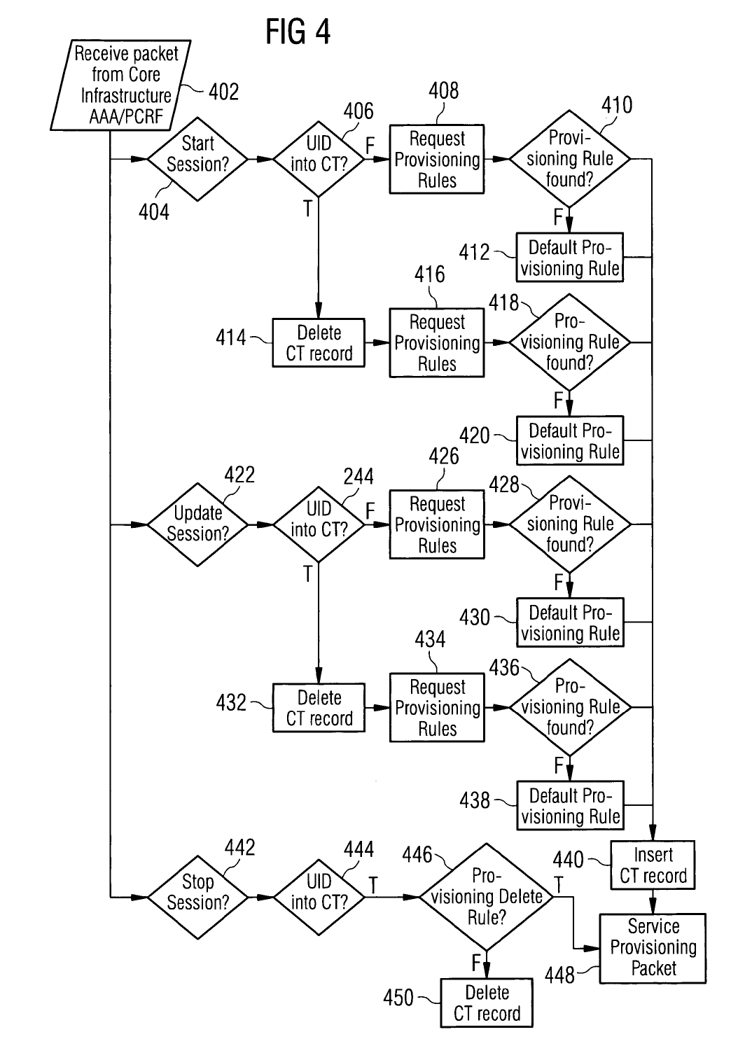

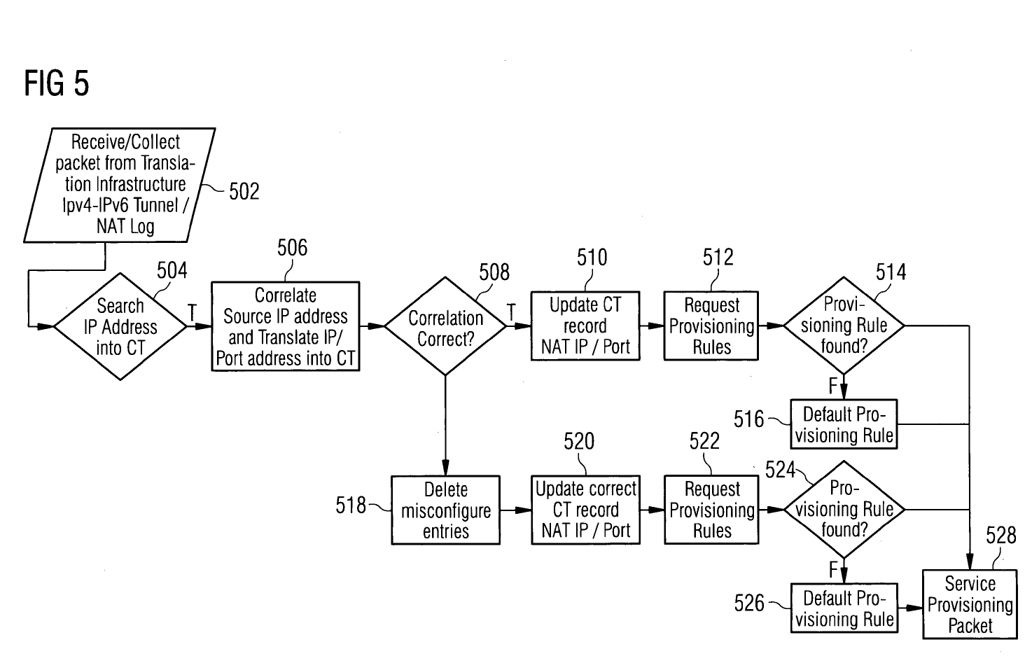

The present invention is implemented with two principal algorithms
1. Core infrastructure correlation algorithm, based on the information provided by session control services (AAA, PCRF, etc . . . ) that provides control of the subscribers session and the inclusion of this information into the connection table (CT) that includes subscriber Id and IP addressing information. FIG. 4 is a flowchart representing the detailed algorithm of the Core infrastructure correlation module; and
2. IP Translation infrastructure collect algorithm, based on the information provided by the IP translation services (NAT, IPv4-IPv6 tunneling, etc . . . ) that will provide update information related to IP addressing and Port ranges addressing of subscribers. FIG. 5 is a flowchart representing the detailed algorithm of the IP translation infrastructure correlation module.

Referring to FIG. 4, the algorithm of the Core infrastructure correlation module begins with the reception of a packet from the Core Infrastructure AAA/PCRF (box 402). The processing takes one of three possible paths, depending upon whether the session is to be started (box 404), updated (box 422), or stopped (box 442).

The start session (box 404) and update session (box 422) paths are identical to one another. In the first step of each (box 406/box 424), an inquiry as to whether the user identification (UID) is in connection table (CT) is made. If the answer is “no”, a provisioning rule is requested (box 408/box 426). If a provisioning rule is found (box 410/box 428), the UID is inserted into the connection table (box 440), and a provisioning packet is serviced (box 448). If a provisioning rule is not found (box 410/box 428), a default provisioning rule is used (box 412/box 430), and the UID is inserted into the connection table (box 440), and a provisioning packet is serviced (box 448).

On the other hand, if the answer to the inquiry whether the user identification (UID) is in connection table (CT) is “yes”, the connection table record is deleted (box 414/box 432), and a provisioning rule is requested (box 416/box 434). If a provisioning rule is found (box 418/box 436), the UID is inserted into the connection table (box 440), and a provisioning packet is serviced (box 448). If a provisioning rule is not found (box 418/box 436), a default provisioning rule is used (box 420/box 438), and the UID is inserted into the connection table (box 440), and a provisioning packet is serviced (box 448).

The stopped session (box 442) begins with an inquiry (box 444) whether the user identification (UID) is in connection table (CT) (box 444). If the answer is “yes”, an inquiry whether to delete the provisioning rule is made (box 446). If the answer is “no”, the connection table record is deleted (box 450). If the answer is “yes”, a provisioning packet is serviced (box 448).

Referring to FIG. 5, the algorithm of the algorithm of the IP translation infrastructure correlation module begins with the reception or collection of a packet from the Translation Infrastructure Ipv4-IPv6 Tunnel/NAT Log (box 502). The algorithm continues with an inquiry whether the IP address and Port ranges address is in the connection table (box 504). If the answer is “yes”, the source IP address is correlated and the IP/Port ranges address are translated into the connection table (box 506). Subsequently, a check whether the correlation is correct is made (box 508).

If the correlation is correct, the connection table record NAT IP/Port ranges are updated (box 510), and a provisioning rule is requested (box 512). If a provisioning rule is found (box 514), a provisioning packet is serviced (box 528). If a provisioning rule is not found (box 514), a default provisioning rule is used (box 516), and a provisioning packet is serviced (box 528).

On the other hand, if the correlation is not correct, misconfigured entries are deleted (box 518), and, subsequently, the connection table record NAT IP/Port ranges are updated (box 520), and a provisioning rule is requested (box 522). If a provisioning rule is found (box 524), a provisioning packet is serviced (box 528). If a provisioning rule is not found (box 524), a default provisioning rule is used (box 526), and a provisioning packet is serviced (box 528).

Both algorithms provide provisioning rules based on the policy provisioning of every service to be provisioned.

Collected information supported by this solution has to be flexible and include standard protocols of Core infrastructure (Radius, Diameter, SOAP) and additional capabilities to collect traffic from services based on translation logging (NAT and Carrier Grade NAT, IP tunneling, Proxies) with traffic capture or log monitoring.

The implementation of this module has to be accomplished with a fast algorithm to provide a real time collection, correlation and provisioning of services, with a minimum delay for information provisioning, thus minimizing the impact of this provisioning service to the provisioned services and minimize networks delays.

Policy provisioning will implement a method to define what information is provided for every service; for instance, services based on IP, based on IP/Port ranges,

IPv6 or IPv4 addressing can be integrated and provisioned based on the information demanded for every service.

It is also necessary to implement an age control mechanism for every entry on the connection table, to implement automatic purge control that permits a control of old entries or orphan sessions inserted in the connection table in a configurable mechanism, that permits a defined retention period for these entries.

The present invention offers, among other things, the following advantages to an operator:
1. Capacity to implement subscriber/IP flow identification in any translation (NAT/IP tunneling) environment;
2. Provisioning subscriber/IP information to services that require this information in a flexible and fast centralized module;
3. Capacity to provide subscriber/IP addressing information based on a policy provisioning and flexibility to evolve this module with new interfaces or protocol that provide or demand this information;
4. Taking into account real demands of an operator's network evolutions, the invention implements a smart solution that permits the capture of all information of subscriber and IP address services provisioning and the information of translate services, correlated and managed based on service specific rules, and provisioning of this information to specific services that demand this information, in real time; and
5. Protect previous investments into services that are based on subscriber and IP addressing identification into CSP that are implementing mechanisms to migrate IPv6 or NAT infrastructures.

The following are some use cases that are addressed by the present invention:
1. Content filtering based on subscriber and IP address information to provide filtering policies per IP address, in NAT environments. This module can provide update information to identify IP flow per subscriber;
2. Subscriber with IPv4 that are accessing to IPv6 services in an IPv6 tunneling infrastructure. This module can provide subscriber information to these services based on IPv6 source tunneling information.
3. Services that implement a multi-factor authentication mechanism, and use IP addressing to provide one of the authentication factors—in NAT/IPv6 tunnelling environments this information is not valid. This module can provide subscriber IP addressing information; and
4. Networks services (DPI, QoS modules) that need subscriber IP flow identification to apply specific network QoS or control—in NAT/IP tunneling environments this control is lost. This module can provide subscriber IP addressing information to these services and apply specific QoS or control policy.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional non-transitory computer-readable media. In the context of this document, a “non-transitory computer-readable medium” may be any media or means that can contain, store, communicate, propagate or transport the instructions for use by or in connection with an instruction execution system, apparatus, or device, such as a computer. A non-transitory computer-readable medium may comprise a computer-readable storage medium (e.g., memory or other device) that may be any media or means that can contain or store the instructions for use by or in connection with an instruction execution system, apparatus, or device, such as a computer. As such, the present invention includes a computer program product comprising a computer-readable storage medium bearing computer program code embodied therein for use with a computer, the computer program code comprising code for performing any of the methods and variations thereof as previously described. Further, the present invention also includes an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
AAA Authentication/Authorization/Accounting
BRAS Broadband Remote Access Server
CGNAT Carrier Grade Network Address Translation
CSP Communication Service Provider
CT Connection Table (Subscriber Id, IP, Port ranges)
DPI Deep Packet Inspection
EAP Extensible Authentication Protocol
GGSN Gateway GPRS Support Node
GPRS General Packet Radio Service
IAAS Infrastructure as a Service
IP Internet Protocol
IPv4 IP version 4
IPv6 IP version 6
MSISDN Mobile Station International Subscriber Directory Number
NAT Network Address Translation
NAPT Network Address and Port Translation
PAAS Platform as a Service
PCRF Policy Charging and Rules Function
PGW Packet Gateway
QoS Quality of Service
SAAS Software as a Service
SAML Security Assertion Markup Language
SOAP Simple Object Access Protocol
UID User Identification/Subscriber Identification
VAS Value-added Services

1. A method comprising:
collecting interface information on a plurality of services, said services including core infrastructure and translation services;
correlating the interface information to provide subscriber and IP addressing information; and
provisioning the subscriber and IP addressing information to different services based on a rule provisioning policy.

2. The method as claimed in claim 1, wherein said services include at least one of AAA services and PCRF services.

3. (canceled)

4. The method as claimed in claim 1, wherein the interface information is correlated in real time.

5. The method as claimed in claim 1, wherein the correlating is accomplished using a core infrastructure correlation algorithm.

6. The method as claimed in claim 1, wherein the correlating is accomplished using an IP translation infrastructure correlation module.

7. An apparatus comprising:
one or more processors; and
one or more memories including computer program code;
the one or more memories and the computer program code configured, with the one or more processors, to cause the apparatus to perform:
collecting interface information on a plurality of services, said services including core infrastructure and translation services;
correlating the interface information to provide subscriber and IP addressing information; and
provisioning the subscriber and IP addressing information to different services based on a rule provisioning policy.

8. The apparatus as claimed in claim 7, wherein said services include at least one of AAA services and PCRF services.

9. (canceled)

10. The apparatus as claimed in claim 7, wherein the interface information is correlated in real time.

11. The apparatus as claimed in claim 7, wherein the correlating is accomplished using a core infrastructure correlation algorithm.

12. The apparatus as claimed in claim 7, wherein the correlating is accomplished using an IP translation infrastructure correlation module.

13. An apparatus comprising:
means for collecting interface information on a plurality of services, said services including core infrastructure and translation services;
means for correlating the interface information to provide subscriber and IP addressing information; and
means for provisioning the subscriber and IP addressing information to different services based on a rule provisioning policy.

14. The apparatus as claimed in claim 13, wherein said services include at least one of AAA services and PCRF services.

15. (canceled)

16. The apparatus as claimed in claim 13, wherein the interface information is correlated in real time.

17. The apparatus as claimed in claim 13, wherein the correlating is accomplished using a core infrastructure correlation algorithm.

18. The apparatus as claimed in claim 13, wherein the correlating is accomplished using an IP translation infrastructure correlation module.

19. A computer program product comprising a non-transitory computer-readable storage medium bearing computer program code embodied therein for use with a computer, the computer program code comprising:
code for collecting interface information on a plurality of services, said services including core infrastructure and translation services;
code for correlating the interface information to provide subscriber and IP addressing information; and
code for provisioning the subscriber and IP addressing information to different services based on a rule provisioning policy.

20. The computer program product as claimed in claim 19, wherein said services include at least one of AAA services and PCRF services.

21. (canceled)

22. The computer program product as claimed in claim 19, wherein the interface information is correlated in real time.

23. The computer program product as claimed in claim 19, wherein the correlating is accomplished using a core infrastructure correlation algorithm.

24. The computer program product as claimed in claim 19, wherein the correlating is accomplished using an IP translation infrastructure correlation module
